(19) United States
(12) Patent Application Publication
(10) Pub. No.: US 2016/0032622 A1
(43) Pub. Date: Feb. 4, 2016

(54) MORTISE LOCK

(71) Applicant: Milda Co. Ltd., Gyeonggi-do (KR)

(72) Inventor: Sang Hoon Shin, Seoul (KR)

(21) Appl. No.: 14/643,408

(22) Filed: Mar. 10, 2015

(30) Foreign Application Priority Data
Jul. 31, 2014 (KR) 10-2014-0098297

(51) Int. Cl. E05B 63/08

(52) U.S. Cl. CPC E05B 63/08

(57) ABSTRACT

Disclosed herein is a mortise lock which can open a door when a user pushes or pulls a knob. The mortise lock includes: a knob configured to be pushed and pulled by a user; a rose which is mounted at one side of the front face and the rear face of the door and to which one side of the knob is inserted and fixed in such a manner that the knob can be rotated; a gear guide to which one side of the knob inserted into the rose is connected and which is configured to vertically slide according to rotation of the knob; and a latch actuating part of which one side is connected with the gear guide and of which the other side is connected with the latch so as to be moved in a specific direction by the vertical sliding of the gear guide, wherein when the latch actuating part is moved in the specific direction, the latch is inserted or protrudes out. The mortise lock can easily open the door just by the user's one-step action to push or pull the knob indoors or outdoors.

### CROSS-REFERENCE TO RELATED APPLICATIONS

The present application claims the benefit of Korean Patent Application Serial No. 10-2014-0098297, which was filed on Jul. 31, 2014 and is hereby incorporated by reference.

### BACKGROUND OF THE INVENTION

1. Field of the Invention

The present invention relates to a mortise lock, and more particularly, to a mortise lock which includes an opening part and a locking part of the conventional mortise lock and can open a door not in the manner to rotate or downwardly press a lever but in a new manner to push or pull a knob in any direction indoors or outdoors, differently from a conventional door lock which opens or closes the door from the outside using the lever.

2. Background Art

A mortise lock (mortice lock in British English) means a door lock which includes a locking part, an opening part, and a dead bolt mounted at the locking part. FIG. 1 is a perspective view of a conventional mortise lock. As shown in FIG. 1, the conventional mortise lock includes a dead bolt 1, a key hole 2, a knob 3, a hinge 4, a face plate 5, a latch 6, and so on. A door keep to which the latch 6 and the dead bolt 1 are inserted is mounted on a door jamb.

Differently from the conventional door lock, the mortise lock has a latch of the locking part which is not connected with the knob, separately from the latch 6 connected with the handgrip in order to provide a stable locking state. The latch 6 of the opening part of the mortise lock is connected with the knob as in general door locks, but does not provide a locking function of the general door locks. Therefore, the latch 6 connected with the knob in the mortise lock is called ‘sash locks’. The latch of the locking part which is not connected with the knob is called a ‘dead bolt’ or a ‘dead lock’. The dead bolt is connected with a key device to lock the door.

The mortise lock is not difficult to be installed in comparison with other door locks, but, is stronger in a locked state than general bored cylindrical locks.

Such a mortise lock generally has a lever type or a round shaped knob 3 and takes a rotating manner. FIG. 2 is a mimetic diagram showing the inside of the conventional mortise lock. As shown in FIG. 2, the mortise lock has a spindle block 9, a spindle 8, a latch actuating part 7 and a latch 6 therein. When a user rotates the knob, the spindle block 9 is rotated in a specific direction, and the spindle 8 is also rotated in the specific direction by the spindle block 9 rotating in the specific direction. In this instance, if the specific direction is the direction to push the latch actuating part 7, the latch actuating part 7 is pushed back and the latch 6 enters in the door to open the door. If the direction to rotate the knob of the door is the opposite direction, a protruding part (S) of the spindle 8 gets in contact with a rotation preventing part (B), such that the user cannot rotate the knob over a specific angle because the protruding part (S) of the spindle 8 gets in contact with the rotation preventing part (B).

### PRIOR ART DOCUMENTS

### Patent Documents

Patent Document 1: Korean Patent No. 10-0554703

Patent Document 2: Korean Patent Laid-open No. 10-2009-0001266

### SUMMARY OF THE INVENTION

The opening part of the conventional mortise lock can open the door only when the user rotates the knob in one direction with the hand. That is, the conventional mortise lock opens the door through the four steps of: grasping the knob with the hand (first step), applying power to the knob (second step), rotating the knob (third step), and opening the door (fourth step).

Therefore, the conventional mortise lock has a problem in that it is difficult for users who are difficult in using the hands to open the door or it is difficult to open the door in situations to use the hands. Therefore, the present invention has been made to solve the above-mentioned problems occurring in the prior arts.

It is an object of the present invention to provide a mortise lock which can easily open and close a door just by pushing or pulling a knob of the door without grasping and rotating the knob of the door with the hand and provide improved repeatability of operation, and a door using the mortise lock.

To accomplish the above object, according to the present invention, there is provided a mortise lock which is mounted inside a door, determines opening and closing of the door by protrusion and entry of a latch, determines locking of the door by protrusion of a dead bolt and determines a release of locking of the door by entry of the dead bolt, the mortise lock including: a knob configured to be pushed and pulled by a user; a rose which is mounted at one side of the front face and the rear face of the door and to which one side of the knob is inserted and fixed in such a manner that the knob can be rotated; and a latch actuating part of which one side is connected with one side of the knob inserted into the rose and of which the other side is connected with the latch so as to be moved in a specific direction by rotation of the knob, wherein when the latch actuating part is moved in the specific direction, the latch is inserted.

In another aspect, there is provided a mortise lock including: a knob configured to be pushed and pulled by a user; a rose which is mounted at one side of the front face and the rear face of the door and to which one side of the knob is inserted and fixed in such a manner that the knob can be rotated; a gear guide to which one side of the knob inserted into the rose is connected and which is configured to vertically slide according to rotation of the knob; and a latch actuating part of which one side is connected with the gear guide and of which the other side is connected with the latch so as to be moved in a specific direction by the vertical sliding of the gear guide, wherein when the latch actuating part is moved in the specific direction, the latch is inserted.

In a further aspect, there is provided a mortise lock including: a knob configured to be pushed and pulled by a user; a rose which is mounted at one side of the front face and the rear face of the door and to which one side of the knob is inserted and fixed in such a manner that the knob can be rotated; a gear guide to which one side of the knob inserted into the rose is connected and which is configured to vertically slide according to rotation of the knob; a gear of which one side is engaged with the inside of the gear guide so as to be rotated in a specific direction by the vertical sliding of the gear guide; and a latch actuating part of which one side is connected with the other side of the gear and of which the other side is connected with the latch so as to be moved in a specific direction, wherein when the latch actuating part is moved in the specific direction, the latch is inserted.

In a still further aspect, there is provided a mortise lock including: a knob configured to be pushed and pulled by a user; a rose which is mounted at one side of the front face and the rear face of the door and to which one side of the knob is inserted and fixed in such a manner that the knob can be rotated; a gear guide to which one side of the knob inserted into the rose is connected and which is configured to vertically slide according to rotation of the knob; a gear of which one side is engaged with the inside of the gear guide so as to be rotated in a specific direction by the vertical sliding of the gear guide; a spindle block of a polyprism shape of which one end is connected with one side of the gear so as to be rotated integrally with the gear; a disc-shaped spindle which is connected with the other end of the spindle block to be rotated integrally with the spindle block and which has two protrusions formed on the outer circumference; and a latch actuating part of which one side gets in contact with the protrusion of the spindle and of which the other side is connected with the latch so as to be moved in a specific direction, wherein when the latch actuating part is moved in the specific direction, the latch is inserted, and the spindle has two members which respectively corresponds to an inner knob and an outer knob and are operated separately from each other.

As described above, the mortise lock according to the present invention has the following effects.

First, the mortise lock according to the embodiment of the present invention can easily open the door just by one step operation to push or pull the knob of the door indoors or outdoors. Therefore, in case of emergency, such as a fire, or in case of users who are holding things in both hands, children, patients or disabled persons, they can easily open and close the door using a part of the body without directly using the hands.

Second, the mortise lock according to the embodiment of the present invention can be applied to all kinds of doors, such as pulling type doors, sliding doors, left-side knob doors and right-side knob doors, and hence, can be directly applied even though any type of the door is mounted to a building. Typically, door locks are different according to kinds of doors mounted to a building.

Third, the mortise lock according to the embodiment of the present invention is simple in structure and is easy and fast in repair and replacement when the mortise lock is damaged because it does not needs a plurality of connection tools.

Fourth, the mortise lock according to the embodiment of the present invention can minimize a contact surface between the user's hand and the knob of the door when the user opens or closes the door, thereby contributing on promotion of hygiene.

Fifth, the mortise lock according to the embodiment of the present invention provides a stable locking device and improves repeatability due to a simple structure.

Sixth, the mortise lock according to the embodiment of the present invention can keep accuracy in spite of repeated operation of the door opening device and remarkably reduce an operation error rate.

Seventh, the mortise lock according to the embodiment of the present invention is not limited to the simple appearance of the knob of the conventional mortise lock but provides various shapes of the knob of the door because there is no need to rotate the knob.

Eighth, the mortise lock according to the embodiment of the present invention provides an effect that the knob of one side is not moved even though the knob of the other side is pulled or pushed. That is, the knobs of both sides are operated separately.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a conventional mortise lock;

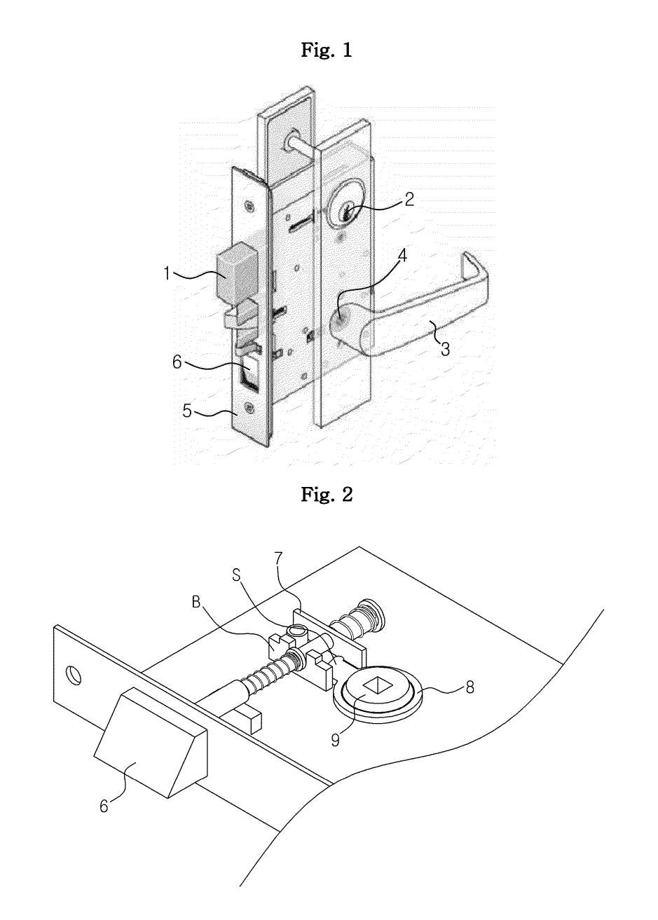

FIG. 2 is a mimetic diagram showing the inside of the conventional mortise lock;

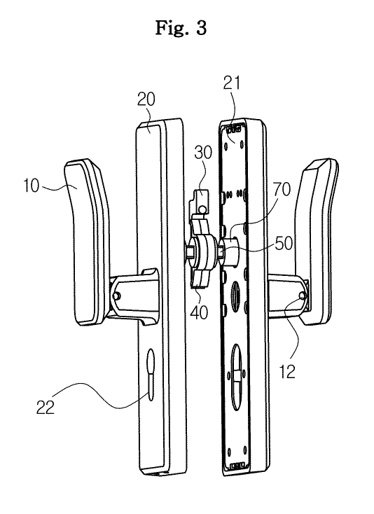

FIG. 3 is a perspective view of a mortise lock according to a preferred embodiment of the present invention;

FIG. 4 is an exploded perspective view showing a part of the mortise lock according to the preferred embodiment of the present invention;

FIG. 5 is a perspective view showing the part of the mortise lock according to the preferred embodiment of the present invention; and

FIGS. 6 and 7 are mimetic diagrams showing working relationship between a spindle and a latch actuating part of the mortise lock according to the preferred embodiment of the present invention.

### DETAILED DESCRIPTION OF THE PREFERRED EMBODIMENT

Reference will be now made in detail to the preferred embodiments of the present invention with reference to the attached drawings. In the description of the present invention, when it is judged that detailed descriptions of known functions or structures related with the present invention may make the essential points vague, the detailed descriptions of the known functions or structures will be omitted.

Moreover, in the drawings, parts having similar functions and actions have the same reference numerals. In the description of the present invention, to connect some part with another part means that some part is directly connected with another part and that some part is indirectly connected with another part through an element. Furthermore, unless otherwise defined herein, to include a component does not mean that the mortise lock excludes other component but means that the mortise lock can include other components more.

Mortise Lock

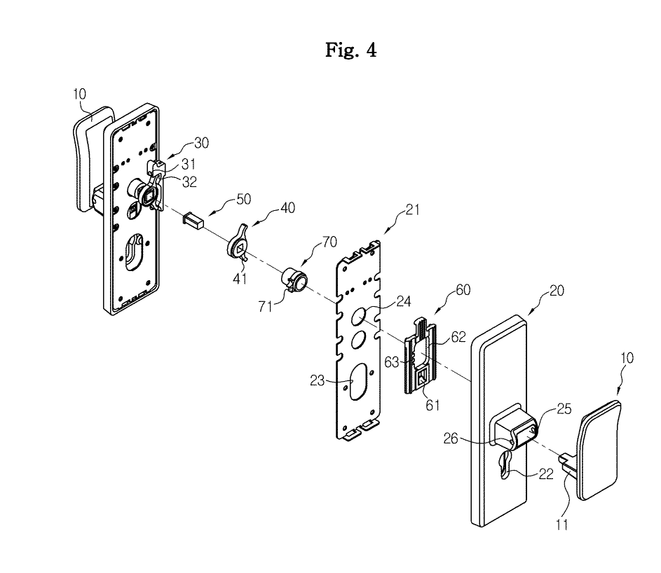

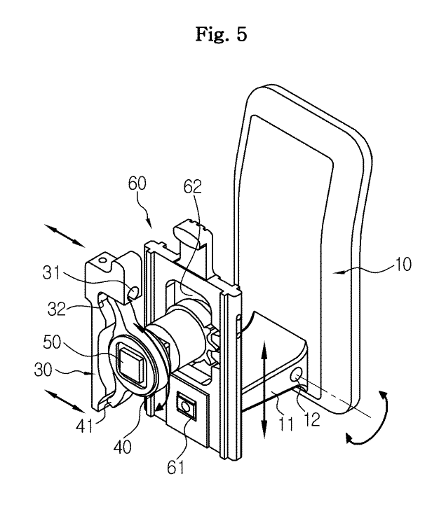

In relation with the mortise lock, FIG. 3 is a perspective view of a mortise lock according to a preferred embodiment of the present invention, and FIG. 4 is an exploded perspective view showing a part of the mortise lock according to the preferred embodiment of the present invention. As shown in FIGS. 3 and 4, the mortise lock according to the preferred embodiment of the present invention includes a knob 10, a rose 20, a bracket 21, a latch actuating part 30, a spindle 40, a spindle block 50 and a gear 70.

The knob 10 takes a plate form that a user can push or pull. Moreover, the knob 10 can be forwardly tilted at a specific angle, so that a user can easily push or pull the knob. Additionally, the knob 10 may have a protrusion 11 which protrudes backwardly at one side of the rear face and is inserted into one side of the rose 20. The knob 10 has a shaft hole 12 formed at one side of the protrusion 11 in such a way that a shaft of a rotary shaft is inserted into the shaft hole 12. The knob 10 is rotated around the shaft hole 12 to provide a gear guide 60 with a vertical operation force. When the user pulls the knob, the protrusion 11 moves upwardly. Forms of the knob may be selected according to purposes or the user's tastes.

The rose 20 is formed in a plate type and is attached and fixed to the door. The rose has an insertion hole 25 formed at one side of the front face thereof, and the protrusion 11 of the knob 10 is inserted into the insertion hole 25. The rose 20 further has a shaft hole 26 formed at one side of the insertion hole 25 and at a position corresponding to the shaft hole 12 of the knob. When the shaft is inserted and fixed into the shaft holes 12 and 26, the knob 10 and the rose 20 are connected rotatably. Moreover, the rose 20 has a key hole 22 to which a key device will be mounted and which is formed at one side of the front face thereof. The gear guide 60 may be arranged inside the rose 20 in such a way as to carry out a vertical reciprocating motion. The bracket 21 is mounted at the rear face of the rose 20 to protect that the gear guide 60 and the gear 70 can freely carry out the reciprocating motion inside the rose 20. Such a rose 20 may be mounted inside and outside the door in such a way as to be symmetrical with each other from the door.

The bracket 21 is mounted at the rear face of the rose 20 to protect the gear guide 60 and the gear 70. The bracket 21 has a gear hole 24 through which the gear 70 passes and a key hole 23 through which a key passes.

The latch actuating part 30 is connected with the latch at a latch connection part 31 of one end thereof in order to promote the reciprocating motion of the latch. The latch actuating part 30 comes into contact with the spindle 40 and carries out the reciprocating motion in the motion direction of the latch. The latch actuating part 30 has a fitting part 32 to which a protrusion 41 of the spindle 40 is partially inserted in a press fit manner. When the spindle 40 rotates in any direction, the latch actuating part 30 moves in the direction that the latch moves inside the door. The latch actuating part 30 may have an elastic member connected to one side thereof to provide elasticity in the opposite direction to the direction that the latch moves. Even though the spindle 40 is divided into an inner spindle and an outer spindle according to the preferred embodiment of the present invention, the mortise lock according to the present invention can have just one latch actuating part 30, and the latch actuating part 30 gets in contact with the inner spindle and the outer spindle.

The spindle block 50 penetrates through the center of the spindle 40, and the latch actuating part 30 is connected to the spindle 40. The spindle 40 has a protrusion 41 formed at least one side thereof, and the protrusion 41 of the spindle 40 is partially matched with the fitting part 32 of the latch actuating part 30 in shape, such that the protrusion 41 pushes the fitting part 32 of the latch actuating part 30 to move the latch actuating part 30 in one direction when the spindle 40 rotates in a specific direction. According to the preferred embodiment of the present invention, the two protrusions 41 are formed at upper and lower portions of the spindle 40 from the rotary shaft and come into contact with the latch actuating part 30, such that the protrusions 41 push the fitting part 32 of the latch actuating part 30 in any rotation direction of the spindle 40. Because the two protrusions 41 are formed at upper and lower portions of the spindle 40 from the rotary shaft, the mortise lock can realize a push-and-pull type.

That is, the spindle 40 according to the preferred embodiment of the present invention is not limited in the rotation direction and does not need a rotation preventing part differently from the spindle of the conventional mortise lock.

The spindle 40 is configured to rotate together with the gear 70 by the spindle block 50.

The spindle 40 may be separated into an inner spindle connected with an inner knob and an outer spindle connected with an outer knob. The inner spindle and the outer spindle may be respectively provided with operation power by an inner spindle block and an outer spindle block. The inner spindle block and the outer spindle block do not interfere with each other in operation. Such inner and outer spindles may share one latch actuating part 30 and get in contact with the latch operating part 30. The reason is that one latch needs one latch actuating part.

The spindle block 50 is a member to connect the spindle 40 and the gear 70 with each other to transfer a rotary force of the gear 70 to the spindle 40. According to the preferred embodiment of the present invention, the spindle block 50 is formed short in order to separate operation by the inner knob from operation by the outer knob. Accordingly, the inner knob and the outer knob are operated separately from each other.

The gear 70 converts the vertical reciprocating motion of the gear guide 60 into a rotating motion. The gear 70 has a plurality of convex parts 71 formed at one side of the outer rim of a cylindrical member formed in the thickness direction of the door. Such convex parts 71 are engaged with concave parts 63 formed on the inner side of the gear guide 60. The spindle block 50 is inserted into the gear 70 to be rotated integrally. The gear 70 passes through the bracket 21.

The gear guide 60 vertically reciprocates inside the rose 20 by an external force applied to the knob 10 by the user. While the gear 70 passes inside the gear guide 60, the convex parts 71 of the gear 70 go in while engaging with the concave parts 63 of the gear guide 60. The gear guide 60 has a gear hole 62 to provide a space to always maintain engagement of the gear 70 when the gear guide 60 carries out the reciprocating motion. A knob connection part 61 which is connected with the knob 10 is formed at one side of the gear guide 60 to provide a vertically operating power. Therefore, the external force applied to the knob 10 is converted and transferred as the vertically operating power to the knob connection part 61 of the gear guide 60, and the vertically operating power of the gear guide 60 is transferred as a rotating power to the gear 70 which rotates in engagement with the inside of the gear guide 60.

Working Relationship of Mortise Lock

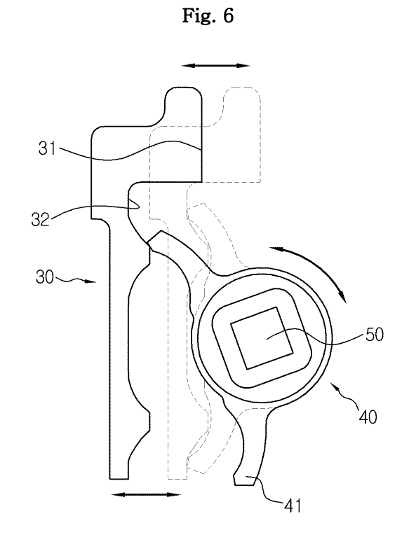

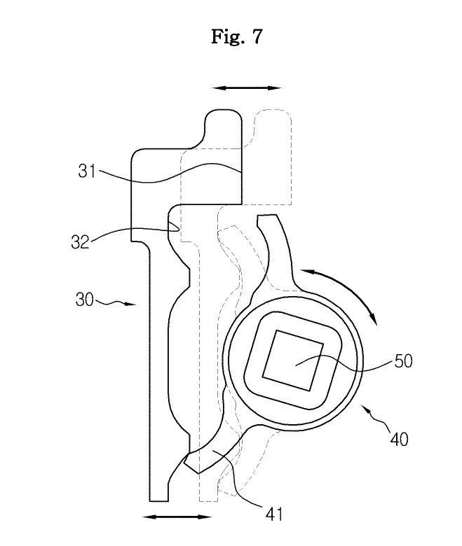

In relation with the working relationship of the mortise lock, FIG. 5 is a perspective view showing the part of the mortise lock according to the preferred embodiment of the present invention and FIGS. 6 and 7 are mimetic diagrams showing working relationship between a spindle and a latch actuating part of the mortise lock according to the preferred embodiment of the present invention. As shown in FIGS. 5, 6 and 7, in the mortise lock according to the preferred embodiment of the present invention, the knob 10 is rotated around the shaft inserted into the shaft hole 12 when the user applies the external force to the knob 10. For instance, when the user pulls the knob 10, the protrusion 11 of the knob 10 moves upwardly. The external force transferred to the protrusion 11 of the knob 10 is transferred to the gear guide 60 so as to make the gear guide 60 slide vertically.

The vertically operating power transferred to the protrusion 11 is transferred to the knob connection part 61 of the gear guide 60, and then, directly transferred to the gear guide 60 as vertically operating power, such that the knob 10 and the gear guide 60 are rotated integrally around the shaft.

The vertical movement of the gear guide 60 rotates the gear 70 which is engaged to the inside of the gear guide 60. Rotation of the gear 70 rotates the spindle block 50, and rotation of the spindle block 50 rotates the spindle 40. Rotation of the spindle 40 moves the latch actuating part 30 in the insertion direction of the latch. Movement of the latch actuating part 30 makes the latch enter into the door. That is, the gear 70, the spindle block 50 and the spindle 40 are rotated integrally, and the rotating force makes the latch actuating part 30 carry out a rectilinear motion.

As described above, the mortise lock according to the preferred embodiment of the present invention realizes the push-and-pull type door lock, reduces a defect rate due to its simple structure, improves repeatability, and is easy and rapid in repair and replacement when it is damaged because it has the simple structure without lots of connection tools.

Moreover, the conventional door lock can realize just a rotating type because the hinge structure is formed in the thickness direction of the door, but the mortise lock according to the preferred embodiment of the present invention can realize the push-and-pull type because the shaft is formed perpendicularly to the thickness direction of the door.

Furthermore, the conventional door lock cannot realize the mortise lock which is pushed and pulled from both sides of the door. However, the mortise lock according to the preferred embodiment of the present invention can realize the mortise lock which is pushed and pulled from both sides of the door because the spindle can be separated into the inner and outer spindles and the spindle block can be separated into the inner and outer spindle blocks.

Additionally, the conventional door lock cannot realize the mortise lock which is pushed and pulled from both sides of the door because the spindle is configured to push the latch actuating part just from one rotation direction. However, the mortise lock according to the preferred embodiment of the present invention can realize the mortise lock which is pushed and pulled from both sides of the door because the spindle can push the latch actuating part in any rotation direction.

As described above, while the present invention has been particularly shown and described with reference to the example embodiment thereof, it will be understood by those of ordinary skill in the art that the present invention can be executed in other forms without changing the technical idea or essential features of the present invention. Therefore, it would be understood that the embodiments disclosed in the present invention are all exemplified and are not limited to the specific embodiment of the present invention. It should be also understood that the protective scope of the present invention is interpreted by the following claims and all changes and modifications derived from the meaning, scope and equivalent concept of the claims belong to the technical scope of the present invention.

What is claimed is:

1. A mortise lock which determines opening and closing of a door by protrusion and entry of a latch, determines locking of the door by protrusion of a dead bolt and determines a release of locking of the door by entry of the dead bolt, the mortise lock comprising:
a knob configured to be pushed and pulled by a user;
a rose which is mounted at one side of the front face and the rear face of the door and to which one side of the knob is inserted and fixed in such a manner that the knob can be rotated; and
a latch actuating part of which one side is connected with one side of the knob inserted into the rose and of which the other side is connected with the latch so as to be moved in a specific direction by rotation of the knob,
wherein when the latch actuating part is moved in the specific direction, the latch is inserted.

2. A mortise lock which determines opening and closing of a door by protrusion and entry of a latch, determines locking of the door by protrusion of a dead bolt and determines a release of locking of the door by entry of the dead bolt, the mortise lock comprising:
a knob configured to be pushed and pulled by a user;
a rose which is mounted at one side of the front face and the rear face of the door and to which one side of the knob is inserted and fixed in such a manner that the knob can be rotated;
a gear guide to which one side of the knob inserted into the rose is connected and which is configured to vertically slide according to rotation of the knob; and
a latch actuating part of which one side is connected with the gear guide and of which the other side is connected with the latch so as to be moved in a specific direction by the vertical sliding of the gear guide,
wherein when the latch actuating part is moved in the specific direction, the latch is inserted.

3. A mortise lock which determines opening and closing of a door by protrusion and entry of a latch, determines locking of the door by protrusion of a dead bolt and determines a release of locking of the door by entry of the dead bolt, the mortise lock comprising:
a knob configured to be pushed and pulled by a user;
a rose which is mounted at one side of the front face and the rear face of the door and to which one side of the knob is inserted and fixed in such a manner that the knob can be rotated;
a gear guide to which one side of the knob inserted into the rose is connected and which is configured to vertically slide according to rotation of the knob;
a gear of which one side is engaged with the inside of the gear guide so as to be rotated in a specific direction by the vertical sliding of the gear guide; and
a latch actuating part of which one side is connected with the other side of the gear and of which the other side is connected with the latch so as to be moved in a specific direction,
wherein when the latch actuating part is moved in the specific direction, the latch is inserted.

4. A mortise lock which determines opening and closing of a door by protrusion and entry of a latch, determines locking of the door by protrusion of a dead bolt and determines a release of locking of the door by entry of the dead bolt, the mortise lock comprising:
a knob configured to be pushed and pulled by a user;
a rose which is mounted at one side of the front face and the rear face of the door and to which one side of the knob is inserted and fixed in such a manner that the knob can be rotated;
a gear guide to which one side of the knob inserted into the rose is connected and which is configured to vertically slide according to rotation of the knob;
a gear of which one side is engaged with the inside of the gear guide so as to be rotated in a specific direction by the vertical sliding of the gear guide;
a spindle block of a polyprism shape of which one end is connected with one side of the gear so as to be rotated integrally with the gear;
a disc-shaped spindle which is connected with the other end of the spindle block to be rotated integrally with the spindle block and which has two protrusions formed on the outer circumference; and
a latch actuating part of which one side gets in contact with the protrusion of the spindle and of which the other side is connected with the latch so as to be moved in a specific direction,
wherein when the latch actuating part is moved in the specific direction, the latch is inserted, and the spindle has two members which respectively corresponds to an inner knob and an outer knob and are operated separately from each other.
